(19) United States
(12) Patent Application Publication
(10) Pub. No.: US 2006/0033682 A1
(43) Pub. Date: Feb. 16, 2006

(54) Plasma display apparatus and driving method thereof

(76) Inventor: Jeong Pil Choi, Suwon-si (KR)

Correspondence Address: MCKENNA LONG & ALDRIDGE LLP;Song K. Jung, 1900 K Street, N.W., Washington, DC, 20006, US

(21) Appl. No.: 11/200,047

(22) Filed: Aug. 10, 2005

(30) Foreign Application Priority Data
Aug. 11, 2004 (KR) 10-2004-0063330

(51) Int. Cl. G09G 3/28

(52) U.S. Cl. 345/60

(57) ABSTRACT

The present invention relates to a plasma display apparatus and method for driving the same, and more particularly, to a plasma display apparatus relating contrast and method for driving the same. A method of driving plasma display apparatus including a scan electrode according to the present invention comprises the steps of starting applying of reset pulse to the scan electrode, altering the end point of falling reset pulse, and stopping applying of reset pulse to the scan electrode. Plasma display apparatus and method for driving the same according to the present invention is able to improve contrast and to reduce operating time.

This Nonprovisional application claims priority under 35 U.S.C. § 119(a) on Patent Application No. 10-2004-0063330 filed in Korea on Aug. 11, 2004 the entire contents of which are hereby incorporated by reference.

### BACKGROUND OF THE INVENTION

1. Field of the Invention

The present invention relates to a plasma display apparatus and method for driving the same, and more particularly, to a plasma display apparatus and method for driving the same relating to contrast.

2. Description of the Background Art

Generally, a plasma display panel displays an image by exciting a fluorescent substance using a UV-ray emitted as a result of a mixed gas discharge involving (He+Xe), (Ne+Xe) or (He+Xe+Ne). Such a plasma display apparatus is easy to implement as a thin and a big sized product. Also, the quality of an image is continuously increasing with the help of technology development.

FIG. 1 illustrates a driving waveform of plasma display panel according to the related art. As shown in FIG. 1, the plasma display panel is driven with the set up and set down period for initializing a whole screen, the address period for selecting the cell, and the sustain period for sustaining a discharge of the selected cell. In this case, Y represents a scan electrode, Z represents a sustain electrode, and X represents an address electrode.

During a setup period, a ramp-up waveform is simultaneously applied to all scan electrodes Y. The ramp-up waveform generates a set up discharge, which is weak discharge, within the discharge cells of a whole screen. Hence, wall charges are accumulated on the cells.

During a setdown period, a ramp-down waveform which falls from a positive voltage that is lower than the peak voltage of the ramp-up waveform is simultaneously applied to scan electrodes Y. The ramp-down waveform causes a weak erasure discharge within the cells, thereby erasing excessive charges among wall charges and space charges generated by the set up discharge. Also, the wall charges uniformly remain within the cells of a whole screen.

During the address period, a scan pulse scan is sequentially applied to the scan electrodes Y, and a positive data pulse which is synchronized with the scan pulse is applied to the address electrodes X. A voltage difference between the scan pulse and the data pulse is added to the wall charge generated in the set up and set down period, thereby generating the address discharge within the cell to which the data pulse is applied.

During the setdown period and the address period, a positive DC voltage that holds sustain voltage level(Vs) is supplied to the sustain electrodes Z

During the sustain period, the sustain pulse Sus is alternately supplied to the scan electrode and the sustain electrode. At the cell selected through the address discharge, whenever the sustain pulse Sus is applied while the sustain pulse Sus is added to the wall voltage within the cell, a sustain discharge as a surface discharge type is generated between the scan electrodes Y and the sustain electrodes Z.

Wall charges within the cell are erased by supplying an erase ramp waveform having a small pulse width after completion of a sustain discharge.

The conventional plasma display panel has general drawbacks such as the contrast being lowered by the light generated in the set up period and the set down period.

Specifically, the ramp-up pulse applied during the set-up period causes a discharge between scan electrodes Y and sustain electrodes Z, and between scan electrodes Y and address electrodes X. In particular, the discharge, which is caused by the ramp-up pulse and generated in between scan electrodes Y and sustain electrodes Z and between scan electrodes Y and address electrodes X, is mainly generated in the closing part of the set up period.

As shown in FIG. 2, wall charges having a negative polarity are generated in scan electrodes Y, and wall charges having positive polarity is generated in sustain electrodes Z.

FIG. 2 illustrates wall charges accumulated within the cell after the set-up period and the set-down period.

It is known that the voltage of discharge between scan electrodes Y and sustain electrodes Z is lower than that of discharge between scan electrodes Y and address electrodes X.

As shown in FIG. 1, the discharge between scan electrodes Y and sustain electrodes Z is caused by the increasing voltage difference between scan electrodes Y and sustain electrodes Z in accordance with applying a set up pulse to scan electrodes Y and applying ground level voltage to sustain electrodes Z during the closing part Td of the set up period.

The light, caused by the discharge between scan electrodes Y and sustain electrodes Z reaches the viewer more easily than the light caused by the discharge between scan electrodes Y and address electrodes X.

The quantity of light, that flows to the viewer, caused by the discharge between scan electrodes Y and sustain electrodes Z is much greater than that of the discharge between scan electrodes Y and address electrodes X. Hence, the characteristic of contrast is decreased as the quantity of light is increased during the set up and the set down period.

The waveform of the plasma display apparatus according to the related art shown in FIG. 3 is suggested to prevent the lowering of contrast.

FIG. 3 illustrates a driving method of a plasma display apparatus according to the related art, and FIG. 4 illustrates an energy recovery circuit used in a plasma display apparatus according to the related art

As shown in FIG. 3, a plasma display apparatus according to the related art is driven by dividing each subfield into the reset period for initializing a whole screen, the address period for selecting the cell, and the sustain period for sustaining a discharge of the selected cell.

The reset period includes a set-up period and a set-down period. During the setup period, a ramp-up waveform is simultaneously applied to all scan electrodes Y. The ramp-up waveform generates a weak discharge within the cells of a whole screen, which causes wall charges within the cells.

In this case, reference voltage is applied to sustain electrodes Z during the initial part of the set-up period, while sustain electrodes Z during the closing part of the set-up period Td maintains a floating state. The floating state of sustain electrodes Z(Y->Z) is maintained until the set-up ramp pulse Ramp-up reaches the peak voltage V2, or during the time of Td. If sustain electrodes Z maintain a floating state, a predetermined voltage is induced to sustain electrodes Z. That is, a predetermined voltage is induced to sustain electrodes Z on account of the voltage of the ramp-up pulse.

At that time, the state of sustain electrodes Z becomes the floating state on account of an energy recovery circuit shown in FIG. 4. Panel capacitor Cp represents the equivalent of a discharge cell equivalently. During the initial part of the set-up period, a fourth switch S4 is turned on, hence, reference voltage GND is applied to sustain electrodes Z. The fourth switch S4 is turned off during the closing part Td of the set-up period. At that time, the first to the third switches S1,S2,S3 maintain a turn off state. Accordingly, sustain electrodes Z maintain a floating state. During the set-down period, sustain voltage level Vs is applied to sustain electrodes Z as the third switch S3 turns on.

When the sustain electrodes Z maintain a floating state, during the closing part Td of the set-up period, a discharge between scan electrodes Y and sustain electrodes Z is not generated, but only a discharge between scan electrodes Y and address electrodes X is generated. In other words, a predetermined ramp voltage may be induced when the sustain electrodes Z maintain floating state during the closing part Td of the set-up period. Then, the voltage difference between scan electrodes Y and sustain electrodes Z may be reduced. Therefore, the surface discharge between scan electrodes Y and sustain electrodes Z may be prevented. Accordingly, luminance in reset period may be lowered, and contrast may be improved.

However, plasma display apparatus according to the related art necessarily requires a period Td in which sustain electrodes Z maintain floating state to prevent surface discharge between scan electrodes Y and sustain electrodes Z during set up period. Hence, plasma display apparatus according to the related art has a limitation in reducing the reset period.

### SUMMARY OF THE INVENTION

Accordingly, an object of the present invention is to solve at least the problems and disadvantages of the background art.

The object of the present invention is to provide a plasma display apparatus and method for driving the same capable of preventing surface discharge between scan electrodes and sustain electrodes during the set up period, while reducing the set up period.

Plasma dislay apparatus according to the present invention comprises a plasma dislay panel including scan electrodes; a scan electrode driving unit for applying a reset pulse to the scan electrodes; and a timing control unit for altering the end point of falling a reset pulse applied by the scan electrode driving unit.

A plasma dislay apparatus according to the present invention comprises a plasma dislay panel including a scan electrode; a scan electrode driving unit for applying reset pulse to the scan electrode; and a timing control unit for altering the end point of falling reset pulse applied by the scan electrode driving unit to be different in at least one subfield.

A method of driving the plasma display apparatus including a scan electrode according to the present invention comprises the steps of starting application of a reset pulse to the scan electrode; altering the end point of falling reset pulse; and stopping application of a reset pulse to the scan electrode.

A plasma display apparatus and the method for driving the same according to the present invention can improve contrast and to reduce driving time.

### BRIEF DESCRIPTION OF THE DRAWINGS

The invention will be described in detail with reference to the following drawings in which like numerals refer to like elements.

FIG. 1 illustrates a driving waveform of plasma display panel according to the related art.

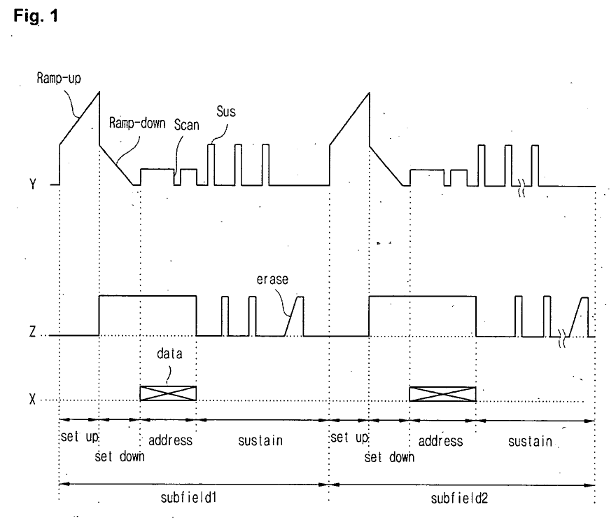

FIG. 2 illustrates wall charges accumulated within the cell after the set-up period and the set-down period.

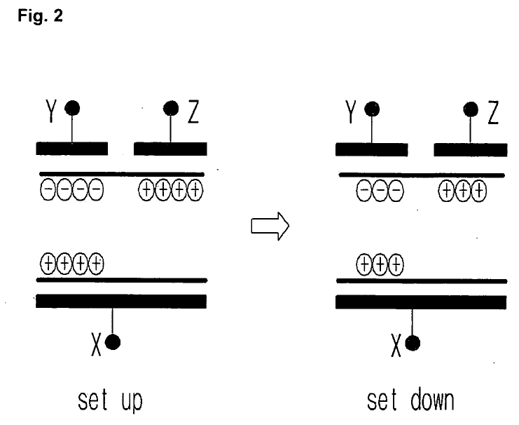

FIG. 3 illustrates a driving method of a plasma display apparatus according to the related art

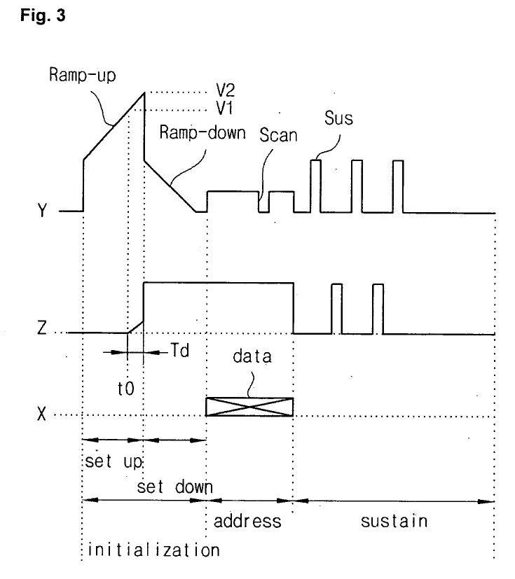

FIG. 4 illustrates an energy recovery circuit used in a plasma display apparatus according to the related art.

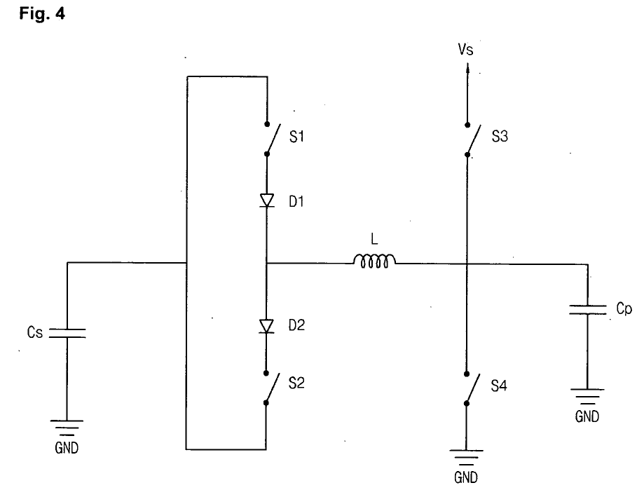

FIG. 5 is a block diagram of plasma display apparatus according to the present invention.

FIG. 6 is a flow chart representing a driving method of plasma display apparatus according to the present invention.

FIG. 7 is a waveform representing a driving method of plasma display apparatus according to a first embodiment of the present invention.

FIG. 8 is a waveform representing a driving method of plasma display apparatus according to a second embodiment of the present invention.

FIG. 9 is a waveform representing a driving method of plasma display apparatus according to a third embodiment of the present invention.

FIG. 10 is a waveform representing a driving method of plasma display apparatus according to a fourth embodiment of the present invention.

### DETAILED DESCRIPTION OF PREFERRED EMBODIMENTS

Preferred embodiments of the present invention will be described in a more detailed manner with reference to the drawings.

Plasma dislay apparatus according to the present invention comprises a plasma dislay panel including scan electrodes; a scan electrode driving unit for applying a reset pulse to the scan electrodes; and a timing control unit for altering the end point of falling a reset pulse applied by the scan electrode driving unit.

In accordance with the present invention, the timing control unit alters the end point of a rising reset pulse.

In accordance with the present invention, the timing control unit differently controls the end point of the falling reset pulse in at least one subfield.

In accordance with the present invention, the timing control unit differently controls the end point of the rising reset pulse and the end point of falling reset pulse in at least one subfield.

In accordance with the present invention, the scan electrode driving unit constantly maintains the gradient of ramp-down pulse included in the reset pulse in each subfield.

In accordance with the present invention, the scan electrode driving unit constantly maintains the gradient of the ramp-up pulse included in the reset pulse in each subfield, and constantly maintains the gradient of the ramp-down pulse included in the reset pulse in each subfield.

In accordance with the present invention, the scan electrode driving unit makes the scan electrodes to be in a floating state in the end point of the falling reset pulse.

In accordance with the present invention, the timing control unit alters the end point of a falling reset pulse according to the end point of the rising reset pulse.

In accordance with the present invention, the timing control unit alters the end point of falling reset pulse according to the end point of rising reset pulse in at least one subfield.

Plasma dislay apparatus according to the present invention comprises a plasma dislay panel including a scan electrode; a scan electrode driving unit for applying reset pulse to the scan electrode; and a timing control unit for altering the end point of falling reset pulse applied by the scan electrode driving unit to be different in at least one subfield.

A method of driving plasma display apparatus including a scan electrode according to the present invention comprises the steps of: starting application of the reset pulse to the scan electrode; altering the end point of the falling reset pulse; and stopping application of the reset pulse to the scan electrode.

In accordance with the present invention, the method of driving plasma display apparatus including a scan electrode further comprises the step of altering the end point of rising reset pulse before the step of altering the end point of falling reset pulse.

In accordance with the present invention, the end point of falling reset pulse is differently controlled in at least one subfield.

In accordance with the present invention, the end point of rising reset pulse and the end point of falling reset pulse are differently controlled in at least one subfield.

In accordance with the present invention, the gradient of ramp-down pulse included in the reset pulse is constantly maintained in each subfield.

In accordance with the present invention, the gradient of ramp-up pulse included in the reset pulse and the gradient of ramp-down pulse included in the reset pulse are constantly maintained in each subfield.

In accordance with the present invention, the scan electrode maintains floating state in the end point of falling reset pulse.

In accordance with the present invention, the end point of falling reset pulse is altered according to the end point of rising reset pulse

In accordance with the present invention, the end point of falling reset pulse is altered according to the end point of rising reset pulse in the at least one subfield.

In accordance with the present invention, the end point of rising reset pulse and the end point of falling reset pulse are the more accelerated in a subfield that has the lower gray level.

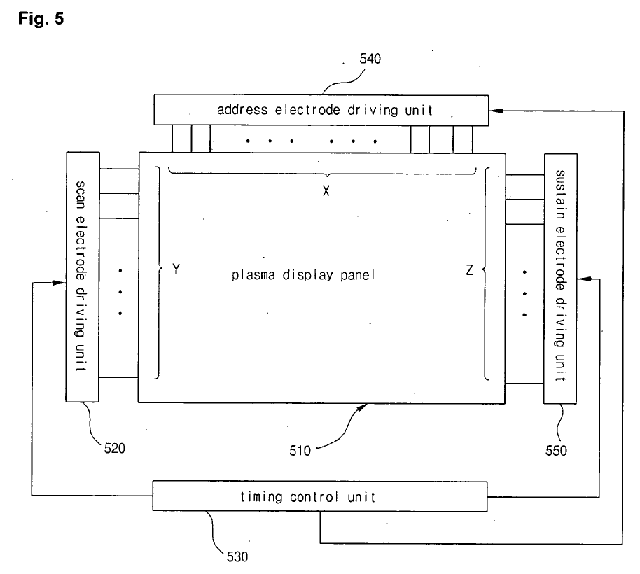

FIG. 5 is a block diagram of plasma display apparatus according to the present invention.

As shown in FIG. 5, plasma display apparatus according to the present invention comprises a plasma display panel 510, a scan electrode driving unit 520 and a timing control unit 530. The plasma display panel 510 includes scan electrodes Y, sustain electrodes Z, and address electrodes X.

Scan electrode driving unit 520 generates uniform wall charges in the whole cells configuring plasma display panel 510 by applying reset pulse to scan electrodes Y. Also, scan electrode driving unit 520 applies scan pulse to select cells for sustain discharge and applies sustain pulse to generate sustain discharge in the selected cell. In this case, it is preferable that reset pulse is comprised of ramp up pulse and ramp down pulse.

Timing control unit 530 alters the end point of falling reset pulse applied from electrode driving unit. Timing control unit 530 alters the end point of falling reset pulse to control the quantity of discharge between scan electrodes Y and sustain electrodes Z.

Timing control unit 530 also can alter the end point of falling reset pulse in at least one subfield.

Timing control unit 530 can more accurately control the quantity of discharge between scan electrodes Y and sustain electrodes Z by altering the end point of rising reset pulse as well as the end point of falling reset pulse.

Timing control unit 530 can differently alter the end point of rising reset pulse and the end point of falling reset pulse in at least one subfield.

Timing control unit 530 can also alter the end point of falling reset pulse according to the end point of rising reset pulse. Preferably, timing control unit 530 controls the end point of falling reset pulse to be accelerated if the end point of rising reset pulse is set to be accelerated.

Timing control unit 530 alters the end point of falling reset pulse according to the end point of rising reset pulse in at least one subfield. Preferably, timing control unit 530 controls the end point of falling reset pulse to be accelerated if the end point of rising reset pulse is set to be accelerated.

As described, embodiments of timing control unit 530 will be described to control the end point of falling reset pulse according to the end point of rising reset pulse.

In this case, scan electrode driving unit 520 constantly maintains the gradient of ramp-up pulse or ramp-down pulse in every subfield regardless of the altering of the end point of rising reset pulse or the end point of falling reset pulse. In other words, scan electrode driving unit 520 controls the voltage level of rising reset pulse by applying ramp-down pulse in the end point of ramp-up pulse controlled by timing control unit 530, after applying ramp-up pulse which rises with a fixed gradient.

In addition, scan electrode driving unit 520 controls the voltage level of falling reset pulse by making scan electrodes Y to be floating state in the end point of ramp-down pulse controlled by timing control unit 530, after applying ramp-down pulse which falls with a fixed gradient In the following embodiments, detailed description on floating state of scan electrodes Y is described.

An address electrode driving unit 540 applies a corresponding address pulse to the address electrodes X synchronized with the scan pulse that scan electrode driving unit 520 applies to one scan electrode. A sustain electrode driving unit 550 applies DC voltage having positive polarity to sustain electrodes Z and applies sustain pulse, that is alternated with a sustain pulse applied to scan electrodes Y, to sustain electrodes Z.

With Reference to the drawings, an embodiment of PDP driving method according to the present invention will now be described.

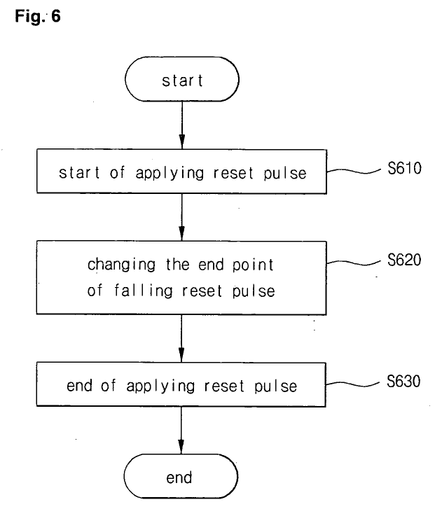

FIG. 6 is a flow chart representing a driving method of plasma display apparatus according to the present invention.

The driving method of plasma display apparatus according to the present invention, it starts with the application of a reset pulse to scan electrode S610. If the reset pulse consists of a ramp-up pulse and a ramp-down pulse, the ramp-up pulse with a fixed gradient is applied to scan electrodes Y before ramp-down pulse is applied to scan electrodes Y.

The timing control unit 530 alters the end point of the falling reset pulse is altered by S620. Accordingly, scan electrode driving unit 520 finishes the application of the reset pulse by stopping the falling reset pulse in the end point of failing reset pulse S630.

An additional detailed description with following 4 embodiments on the above process will be described.

### EMBODIMENT 1

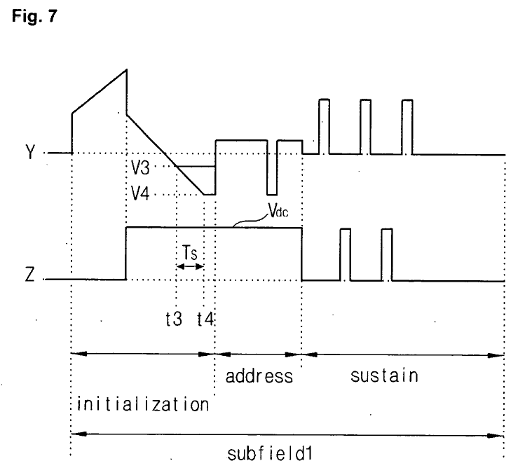

FIG. 7 is a waveform representing a driving method of plasma display apparatus according to a first embodiment of the present invention.

As shown in FIG. 7, in the driving method of plasma display apparatus according to the first embodiment of the present invention, timing control unit 530 alters set-down period by altering the end point of falling reset pulse.

By controlling the end point of ramp-down pulse of timing control Unit 530, if the minimum voltage of ramp-down pulse that scan electrode driving unit 520 applies to scan electrodes Y moves to a third voltage V3 from a fourth voltage V4, the voltage difference between scan electrodes Y and sustain electrodes Z is reduced.

The quantity of discharge between scan electrodes Y and sustain electrodes Z is reduced and, moreover, the quantity of light is also reduced, which makes it possible to improve contrast. In addition, if the minimum voltage of ramp-down pulse moves to the third voltage V3 from the fourth voltage V4, the total operation time may be reduced, as the reset period could be reduced like Ts.

Timing control unit 530 outputs a floating control signal to scan electrode driving unit 520 in the end point of falling reset pulse. Accordingly, scan electrode driving unit 520 controls the scan electrodes Y to maintain floating state. Hence, in the scan electrodes Y, DC voltage such as the third voltage V3 is induced by DC voltage having positive polarity which is induced in sustain electrodes Z.

Scan electrode driving unit 520 maintains the gradient of ramp-down pulse regardless of the altering of end point of ramp-down pulse. In other words, scan electrode driving unit 520 controls the voltage level of falling reset pulse by making scan electrodes Y to be in a floating state in the end point of ramp-down pulse controlled by timing control unit 530, after application of the ramp-down pulse falling with a fixed gradient.

### EMBODIMENT 2

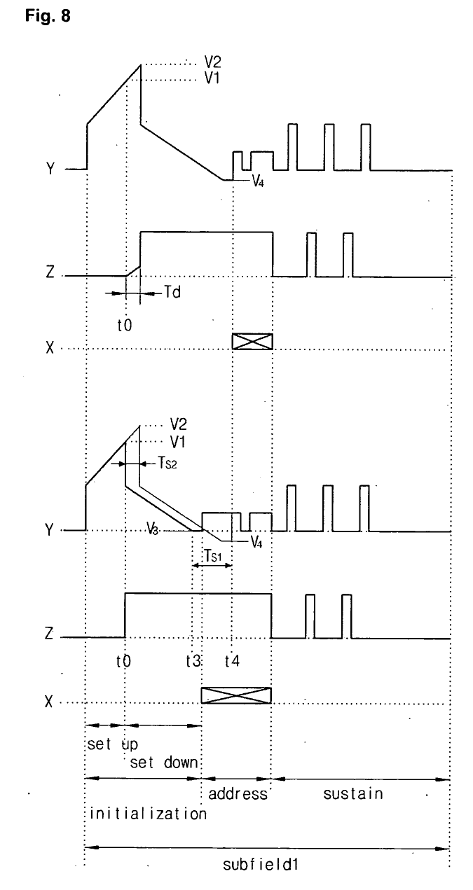

FIG. 8 is a waveform representing a driving method of plasma display apparatus according to a second embodiment of the present invention.

In the upper part of FIG. 8, a conventional waveform is represented to compare with the present invention, and in the lower part of FIG. 8, the driving method according to the second embodiment of the present invention is represented.

As shown in the lower part of FIG. 8, in the driving method according to the second embodiment of the present invention, timing control unit 530 can alter the end point of rising reset pulse as well as the end point of falling reset pulse.

The quantity of discharge between scan electrodes Y and sustain electrodes Z can be accurately controlled by the altering of the end point of rising reset pulse and the end point of falling reset pulse. Details of the altering of end point of falling reset pulse will be abbreviated, as it is the same as that of the first embodiment

As explained in the first embodiment, DC voltage of the end point of ramp-down pulse is generated by setting floating state of scan electrodes Y.

As shown in the upper part of FIG. 8, plasma display apparatus of related art induces the sustain electrode Z to be in a floating state in the closing part Td of set-up period. If the sustain electrode does not enter into a floating state, the voltage difference between scan electrodes Y and sustain electrodes Z in the closing part Td of set-up period is increased to the extent that surface discharge is generated.

If sustain electrodes Z enter into a floating state in the closing part Td of set-up period, the voltage difference between scan electrodes Y and sustain electrodes Z becomes about 0 V. Then, the discharge between scan electrodes Y and sustain electrodes Z is prevented. The process for accumulating enough wall charges in the cells of the whole screen is mainly performed in the initial part of set-up period.

If the set-down period begins in the time point of t0, it is possible to prevent the voltage difference between scan electrodes Y and sustain electrodes Z from enlarging to the extent of surface discharge, while enough wall charges are accumulated in the cells of the whole screen.

In other words, timing control unit 530 can prevent discharge between scan electrodes Y and sustain electrodes Z while enough wall charges are applied in the cells, by altering the end point of rising reset pulse.

Timing control unit 530 may control the end point of falling reset pulse according to the end point of rising reset pulse. That is, if timing control unit 530 raises the voltage level of reset pulse by retarding the end point of rising reset pulse, enough wall charges are accumulated in the cells. Hence, timing control unit 530 may eliminate excessive wall charges by retarding also the end point of falling reset pulse.

If timing control unit 530 lowers the voltage level of reset pulse by accelerating the end point of rising reset pulse, appropriate wall charges are accumulated in the cells. So, timing control unit 530 controls the voltage level of ramp-down pulse not to be in too low level by accelerating also the end point of reset pulse.

In this case, Scan electrode driving unit 520 constantly maintains the gradient of ramp-up pulse and ramp-down pulse regardless of the altering of the end point of rising reset pulse and the end point of falling reset pulse.

In other words, scan electrode driving unit 520 controls the voltage level of rising reset pulse by applying ramp-down pulse in the end point of ramp-up pulse controlled by timing control unit 530, after application of the ramp-up pulse rising with a fixed gradient.

In addition, scan electrode driving unit 520 controls the voltage level of falling reset pulse by making scan electrodes Y to be in a floating state in the end point of ramp-down pulse controlled by timing control unit 530, after application of the ramp-down pulse falling with a fixed gradient.

Accordingly, the quantity of discharge between scan electrodes Y and sustain electrodes Z can be minimized, and then, contrast may be improved. Also, total driving time could be reduced.

### EMBODIMENT 3

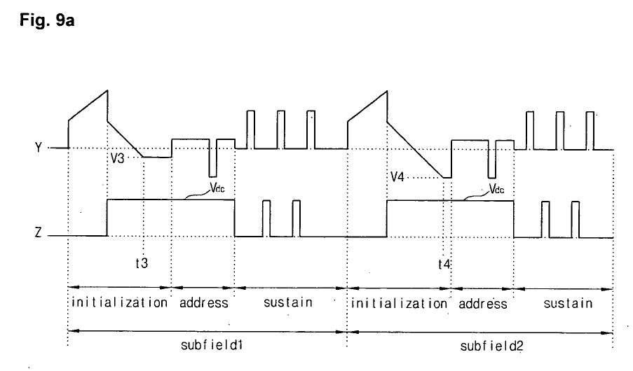

FIG. 9 is a waveform representing a driving method of plasma display apparatus according to a third embodiment of the present invention.

As shown in FIG. 9, in the driving method according to the third embodiment of the present invention, timing control unit 530 controls the end point of falling reset pulse to be different in at least one subfield.

The distribution of wall charge after sustain period is different in each subfield, as a subfield is comprised of sustain pulses that are different each other. Hence, it is more efficient that the end point of falling reset pulse is properly altered for each subfield than the end point of falling reset pulse is the same in every subfield.

As explained in the first embodiment, DC voltage of the end point of ramp-down pulse is generated by making scan electrodes Y to be in a floating state.

Scan electrode driving unit 520 constantly maintains the gradient of ramp-down pulse though the end point of falling reset pulse is altered.

Accordingly, the quantity of discharge between scan electrodes Y and sustain electrodes Z can be minimized in each subfield, and then, contrast may be improved. Also, total driving time could be reduced as reset period could be reduced.

### EMBODIMENT 4

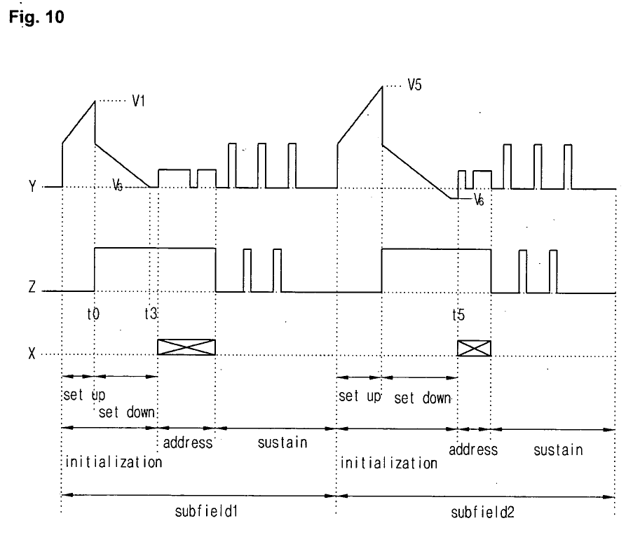

FIG. 10 is a waveform representing a driving method of plasma display apparatus according to a fourth embodiment of the present invention.

As shown in FIG. 10, in the driving method according to the fourth embodiment of the present invention, timing control unit 530 controls the end point of rising reset pulse and the end point of falling reset pulse to be different in at least one subfield

In particular, timing control unit 530 can control the end point of falling reset pulse according to the end point of rising reset pulse applied in each subfield. That is, if timing control unit 530 raises the voltage level of reset pulse by retarding the end point of rising reset pulse in a specific subfield, enough wall charges are accumulated in the cells. Hence, timing control unit 530 may eliminate excessive wall charges by retarding also the end point of falling reset pulse in the specific subfield.

If timing control unit 530 lowers the voltage level of reset pulse by accelerating the end point of rising reset pulse in the specific subfield, appropriate wall charges are accumulated in the cells. So, timing control unit 530 controls the voltage level of ramp-down pulse not to be in too low level by accelerating also the end point of reset pulse in the specific subfield.

In particular, if gray level in a subfield is lower, the end point of rising reset pulse and the end point of falling reset pulse are more accelerated, because low gray level subfield having small number of sustain pulse is less affected by sustain discharge than high gray level.

As explained in the first embodiment, DC voltage of the end point of ramp-down pulse is generated by making scan electrodes Y to be in a floating state.

Scan electrode driving unit 520 constantly maintains the gradient of ramp-up pulse and ramp-down pulse regardless of the altering of the end point of rising reset pulse and the end point of falling reset pulse.

Accordingly, the quantity of discharge between scan electrodes Y and sustain electrodes Z can be minimized, and then, contrast may be improved. Also, total driving time could be reduced.

The invention thus being described, can be varied in many ways. Such variations are not to be regarded as a departure from the spirit and scope of the invention, and all such modifications as would be obvious to one skilled in the art are intended to be included within the scope of the following claims.

What is claimed is:

1. Plasma dislay apparatus comprising:
a plasma dislay panel including scan electrodes;
a scan electrode driving unit for applying reset pulse to the scan electrodes; and
a timing control unit for altering the end point of falling reset pulse applied by the scan electrode driving unit.

2. The plasma dislay apparatus of claim 1, wherein the timing control unit alters the end point of rising reset pulse.

3. The plasma dislay apparatus of claim 1, wherein the timing control unit differently controls the end point of falling reset pulse in at least one subfield.

4. The plasma dislay apparatus of claim 2, wherein the timing control unit differently controls the end point of rising reset pulse and the end point of falling reset pulse in at least one subfield.

5. The plasma dislay apparatus of claim 3, wherein the scan electrode driving unit constantly maintains the gradient of ramp-down pulse included in the reset pulse in each subfield.

6. The plasma dislay apparatus of claim 4, wherein the scan electrode driving unit constantly maintains the gradient of ramp-up pulse included in the reset pulse in each subfield, and constantly maintains the gradient of ramp-down pulse included in the reset pulse in each subfield.

7. The plasma dislay apparatus of claim 1, wherein the scan electrode driving unit makes the scan electrodes to be floating state in the end point of falling reset pulse.

8. The plasma dislay apparatus of claim 2, wherein the timing control unit alters the end point of falling reset pulse according to the end point of rising reset pulse.

9. The plasma dislay apparatus of claim 4, wherein the timing control unit alters the end point of falling reset pulse according to the end point of rising reset pulse in at least one subfield.

10. Plasma dislay apparatus comprising:
a plasma dislay panel including a scan electrode;
a scan electrode driving unit for applying reset pulse to the scan electrode; and
a timing control unit for altering the end point of falling reset pulse applied by the scan electrode driving unit to be different in at least one subfield.

11. A method of driving plasma display apparatus including a scan electrode, the method comprising the steps of:
starting application of the reset pulse to the scan electrode;
altering the end point of falling reset pulse; and
stopping application of the reset pulse to the scan electrode.

12. The method of claim 11, further comprising the step of altering the end point of rising reset pulse before the step of altering the end point of falling reset pulse.

13. The method of claim 11, wherein the end point of falling reset pulse is differently controlled in at least one subfield.

14. The method of claim 12, wherein the end point of rising reset pulse and the end point of falling reset pulse are differently controlled in at least one subfield.

15. The method of claim 13, wherein the gradient of ramp-down pulse included in the reset pulse is constantly maintained in each subfield.

16. The method of claim 14, wherein the gradient of ramp-up pulse included in the reset pulse and the gradient of ramp-down pulse included in the reset pulse are constantly maintained in each subfield.

17. The method of claim 11, wherein the scan electrode maintains floating state in the end point of falling reset pulse.

18. The method of claim 12, wherein the end point of falling reset pulse is altered according to the end point of rising reset pulse

19. The method of claim 14, wherein the end point of falling reset pulse is altered according to the end point of rising reset pulse in the at least one subfield.

20. The method of claim 19, wherein the end point of rising reset pulse and the end point of falling reset pulse are the more accelerated in a subfield that has the lower gray level.
